(19) United States
(12) Patent Application Publication
(10) Pub. No.: US 2005/0211611 A1
(43) Pub. Date: Sep. 29, 2005

(54) Apparatus for the transfer of low density solids in a liquid medium

(76) Inventors: G. Clyde Bazell, Walnut Creek, CA (US); Phillip Glenn Bazell, Lafayette, CA (US)

Correspondence Address: Charles J. Kreling, CFO;Bazell Technologies Corp, Suite D, 5066 Commercial Circle, Concord, CA, 94520, US

(21) Appl. No.: 11/087,118

(22) Filed: Mar. 22, 2005

Related U.S. Application Data
(60) Provisional application No. 60/556,015, filed on Mar. 23, 2004.

(51) Int. Cl. B23Q 11/00; B01D 35/26

(52) U.S. Cl. 210/168; 210/416.1

(57) ABSTRACT

Disclosed is an apparatus for the transfer of low-density solids in a liquid medium. Where the solids have a density near or less than that of the process liquid, transfer of both solids and liquids via pumping mechanisms have proven difficult. The solids are therefore normally removed by various well-known means of filtration or classification prior to pumping the liquid either back to the process or to a remote point. Where it is not practical or preferred to remove solids before transporting the liquid medium, and where it is preferred to transport both liquid and solid phases simultaneously, a means is required to reliably and economically perform this task.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD AND BACKGROUND OF THE INVENTION

The present invention relates to a system for pumping low-density solids in a liquid medium.

A wide variety of manufacturing processes involving milling, cutting, grinding, forming, extruding, and others result in the production of a swarf having unusual characteristics of particle size, shape and density. These particles are removed from the machine tool by flushing with a liquid coolant of various chemical and physical constituents. Classically, the process liquids and solids are expelled from the production machinery by gravity into a tank or containment vessel. Where the solids have a density near or less than that of the process liquid, transfer of both solids and liquids via pumping mechanisms have proven difficult. The solids are therefore ultimately removed by various well-known means of filtration or classification prior to pumping the liquid either back to the process or to a remote point. Where it is not practical or preferred to remove solids before transporting the liquid medium, and where it is preferred to transport both liquid and solid phases simultaneously, a means is required to reliably and economically pump this difficult slurry.

A key reason for the investigation to create the subject invention comes from industries where a disproportionately high volume of solids, relative to the volume of liquids used, are generated in a manufacturing process. Specifically, the subject invention has been tested in a production environment in which six small machine tools each no larger than a phone booth together generate approximately five (5) cubic yards of machined debris during a twenty four hour production period. In environments such as these, it is preferable to instantaneously transport all of the liquids and solids from these individual tools to a single remote point where fluid clarification, temperature maintenance, and debris volume reduction operations can be performed at a central point. The alternative to require multiple systems to provide the same functions local to each production machine is neither space efficient nor economically practical. The automated capabilities of fluid processing systems cannot be cost effectively duplicated where a multiplicity of these systems are required. The subject invention therefore provides real process, economic, and functionality benefits that heretofore have not been available to owners and operators of processes such as those defined in detail below.

The invention herein described presents a unique method for transporting solids laden liquids from the collection point to a remote location. The elevations and distances for transfer are limited only by the relative size and capacity of the components of the invention described.

In many manufacturing processes, fluids are treated with chemical agents or by mechanical means to cause solids in a process liquid to become heavier than the liquid medium or to cause physical suspension of the solids making it possible to transport the liquids and solids from point to point using conventional pump mechanisms. In many cases, the efficacy of these methods are limited by cost, process flow rate, component size, or problematic solids that have the tendency to clog the pump suction or to foul the pump impeller. Further; certain low-density solids tend to remain at the surface and accumulate with no possibility for the solids to reach the pump suction thus negating the efficacy of a transfer tank solution with conventional pump types and orientations.

The invention described presents significant advantages to many processes that otherwise have required removal of low-density solids from the process liquid prior to pumping. The invention has the further capability to operate at process flow rates from zero gallons per minute to the maximum discharge capacity of the accompanying pump.

In examining the technical problems associated with transporting materials of the type described, it was concluded that inverting a submersible pump assembly would present key advantages by 1) eliminating an intermediate tank between the pump and the process, 2) eliminating potential air entrainment in the pump housing which causes loss of prime, and 3) by introducing liquid to the pump suction at a directional rotation common to that of the pump impeller; the pump would perform more efficiently than mounted in the traditional upright position.

Illustrating by specific example, the apparatus has been applied to a manufacturing operation where plastics are machined using a milling cutter. The work piece is flooded by a synthetic coolant at a flow rate of approximately 12 gallons per minute. In a cutting cycle lasting only fourteen seconds, approximately one quart of milled debris characteristically resembling processed coconut and long hair-like strands are released from the production machinery along with the coolant by gravity. Absent the apparatus described, the milled solids reside on the surface of the coolant when released into a process tank due their low density and the presence of air bubbles attached to the plastic particles. Typically in this application transporting the solids and liquids from point to point is accomplished using chemical additives (specifically wetting agents) to alter the surface tension of the liquid phase making sedimentation or suspension of these materials more likely. This method results in a more complex and expensive combination of devices and protocols that are problematic for most operators to effectively manage. No chemical treatment of the process liquids or solids is required to offset the problems of surface tension of the liquid medium or the density problem of the solids. The apparatus has been successfully tested using municipal water and the aforementioned plastic particles without any synthetic coolant concentrate or other chemical additive. This ability provides an additional benefit to processes that could operate on municipal water only but currently require a coolant package with special additives of the type described above.

Using this arrangement there is no requirement for enclosing the pipeline or pump suction to prevent air entrainment and further provides the added benefit of a near fail-safe operation.

Two versions of the apparatus have been developed to suit varying characteristics of the process solids and liquids. In the first version, a cylindrical, conical bottom chamber appropriately sized to suit the operating conditions of the chosen pump is affixed directly to the pump inlet housing. Rotation of the incoming liquid is induced by tangentially entering the liquid into the cylindrical, conical bottom chamber. An additional practical benefit of this chamber is the mixing of the solids and liquids.

In the second version of the invention, the pump suction is directly coupled to the outlet of the process machinery together with the other devices specified later in this document.

### SUMMARY OF THE INVENTION

In accordance with the present invention is a system for pumping liquid laden with low-density solids from a manufacturing process to a subsequent process (e.g. solids removal from the liquid).

According to the teaching of the present invention there is provided a system for transporting fluids containing low-density solids comprising an inlet pipe assembly tangentially connected to a cylindrical/conical bottomed chamber. The chamber is mounted atop an inverted, submersible vortex pump via a bell shaped reducer coupling. The inverted, submersible vortex pump evacuates the low-density solids laden liquid via a swept ell piping section. The entire system is assembled in a enclosing vessel that houses the aforementioned equipment.

Further enhancements and functionality are derived from introducing a fixed overflow port into the inlet pipe to control the maximum fluid level introduced into the inlet chamber. This overflow port sits atop an overflow screen box that captures the debris above a certain particle dimension.

It may be apparent that a useful and novel invention to transfer low-density solids laden liquids has been herein described.

It is an object of the present invention to provide a method for transporting low-density solids laden liquid with a minimum of parts and a minimum interaction between any moving parts of the invention and the solids contained in the liquid to be transported.

What may not be immediately obvious in the invention is the novel use of a traditional submersible vortex pump. The inversion of the pump with liquids introduced in a pre-conditioned, swirling manner of the same direction of the vortex generated by the pump allows the movement of the low-density solids without contact to the pump impellor thus precluding the fouling of the pump impellor.

Yet another object of the present invention is to provide an apparatus for the transport of solids laden liquid to a remotely located, centralized solids removal system so as to minimize the use of the production floor capacity for liquids cleaning apparatus.

Yet another object of the present invention is to provide an apparatus for the transport of solids laden liquid, which is very easily integrated into a continuous system for providing solids free liquid to a machining process.

The invention possesses other objects and advantages especially as concerns particular characteristics and features thereof which will become apparent as the specification continues.

### BRIEF DESCRIPTION OF THE DRAWINGS

The invention is herein described, by way of example only, with reference to the accompanying drawings, wherein:

FIG. 1 is a detailed side view of a first embodiment of a system constructed and operable according to the teachings of the present invention, having been constructed and tested as designated;

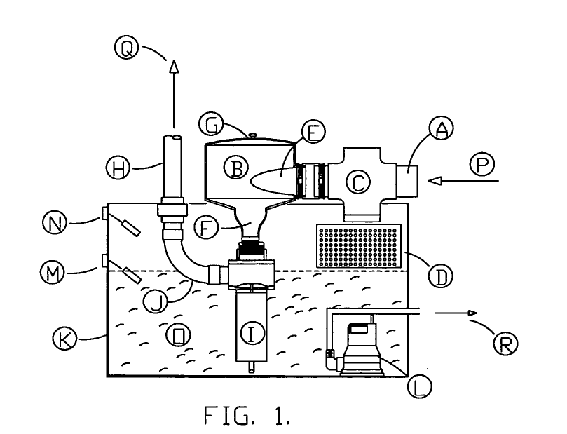

FIG. 2 is a detailed top view of a first embodiment of a system constructed and operable according to the teachings of the present invention, having been constructed and tested as designated;

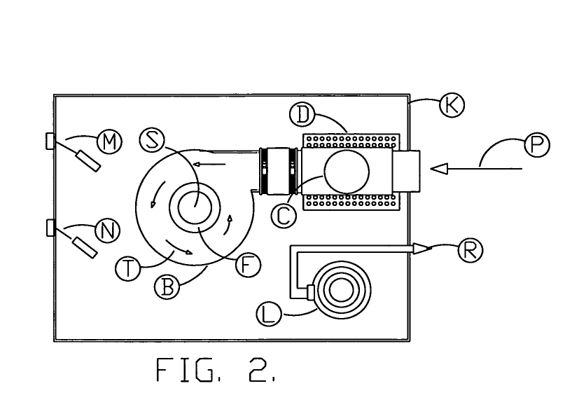

For a better understanding if the invention reference is made to the following detailed description of the preferred embodiments thereof which should be taken in conjunction with the hereinabove described drawings.

### DETAILED DESCRIPTION OF THE PREFERRED EMBODIMENTS

Various aspects of the present invention will evolve from the following detailed description of the preferred embodiments thereof which should be referenced to the prior described drawings.

Process fluid laden with low density solids (P) enters the invention from the upstream tool and/or processes.

An inlet pipe (A) is affixed between the manufacturing process or production machine and the inlet chamber (B). The inlet pipe incorporates a fixed overflow port (C) whose elevation is located to define a maximum fluid level within the pipeline so as not to back up fluid into the prior process step or machine where any failure or blockage of the transport mechanism might occur.

Positioned immediately beneath the overflow port is an overflow screen box (D) manufactured of perforated 304 SS screen material sized to capture debris above a specific particle dimension.

The inlet piping assembly may be alternatively welded, flexibly coupled, threaded, or manufactured as part of the tangential entry tube (E). The tangential entry tube is positioned so as to enter process solids and liquids into the inlet chamber (B) to induce rotation (T) common to that of the pump impeller beneath. The inlet chamber is a cylindrical assembly with a conical bottom terminating at an opening whose dimension is defined by the flow requirements of the process and the volume and condition of the solids entrained in the liquid. Liquid entering the chamber travels approximately 320 degrees until it comes into contact with the following incoming liquid. At this point, re-acceleration of the rotated liquid (T) occurs from the energy of the following liquid and the liquid and debris are further mixed. This design allows irregular or inconsistent flows to be preconditioned before entry into the suction of the pump connected beneath the inlet chamber. At the bottom of the inlet chamber, a bell shaped reducing coupling (F) is affixed. The bell shaped reducing coupling further conditions the fluid/solids mixture by accelerating the rotational speed as the diameter reduces from its inlet to its outlet. Additionally, a smooth transition is created between the pump suction and the inlet chamber free from obstructions that might otherwise inhibit transition of the solids to the suction of the pump beneath (S).

The conditioning chamber has a cover assembly (G) manufactured to a diameter equal to or greater than the opening at the top of the conditioning chamber. The current design is manufactured of clear acrylic material to allow an operator to visually inspect the operation of the assembly beneath. The weight of the cover must be sufficient to hold back the inrush of fluid from the pump discharge pipeline (H) when the system is stopped. The cover may be fastened to the inlet chamber if necessary by various mechanical means and may incorporate electrical or electro-mechanical safety devices integrated to the system electrical controls to prohibit opening during rotation of the moving parts of the pump. The cover assembly can have attached a vertical piece of pipe directly above and partially into the pump inlet causing a quieting effect and providing a barrier to stop large objects from entering the pump impellor and housing. A suspended vertical pipe section from the cover acts as both a trap for foreign objects while also providing the quieting effect of a muffler type device.

In the current invention, a submersible vortex pump (I) is located beneath the inlet chamber and bell shaped reducing coupling. The vortex type submersible pump was chosen for its capability to receive and discharge solids laden fluids without communication of the fluids or solids with the pump impeller. Further, this type of pump has double mechanical seals with lubricating oil filling the void created thereby making operation in a dry state possible. This feature provides the ability to generally avoid fouling of the pump impeller by irregularly shaped solids. Inverting the pump provides a simple means to prevent loss of prime via air pockets that may be induced during exposure of the pump inlet housing during low fluid flow conditions. In this arrangement, fluid presented to the pump inlet housing will cause the pump to fill the discharge pipeline until sufficient volume has been achieved to overcome the elevation of the interconnecting pipeline at its highest point. The outlet coupling or nipple located on the pump housing is coupled to a swept ell piping section (J) selected to smoothly transition the fluids and solids (Q) to the interconnecting discharge pipeline (H).

If a blockage to the pump suction or discharge occurs, fluid will fill the inlet chamber until it begins to backflow through the tangential entry tube and into the inlet tube. When the liquid level reaches the point of the overflow port, liquid and solids escape the opening with fluid passing through the screen box, and solids above the dimension of the screen box are retained. Fluid passing the screen box is captured in the enclosing vessel (K). Located at the bottom of the enclosing vessel is a secondary transfer pump (L) with secondary pump float switch (M) capable of evacuating any overflow liquid from the enclosing vessel at a rate greater than the incoming flow from the overflow port once the solids have been removed by the screen box. A pump of any design capable of sufficient discharge capacity and fluid/solids compatibility could be used for this purpose. The enclosing vessel serves the additional purpose to contain process fluid (O) for the purpose of cooling the submersible vortex pump that operates continuously rather than on the basis of liquid sensing, level switch, or other remote signal. The enclosing vessel is designed to provide a volume sufficient to enclose the devices exposed to fluid (O) at their exterior and to locate and affix said devices in a manner appropriate to good industrial practice and serviceability.

In various iterations of the operating process flow of the system, process fluid in the enclosing vessel is interchanged with process fluid received from an external source (typically the same source as the process fluid of reference here) for temperature maintenance of the submersible vortex pump. Interchange of the cooling fluid is accomplished using various operating scenarios appropriate to the process requirements. These include a continuous flow of any desired volume up to the secondary transfer pumps discharge capacity or an intermittent flow that can be determined via timers or via a temperature sensor coupled to a controller to introduce the interchange fluid at a predetermined set point. A containment vessel with periodic fluid exchange serves as a pump cooling mechanism, an overflow and transfer tank, and an assembly for mounting of components and fluid couplings.

Should the secondary transfer pump fail to evacuate the liquid in sufficient time to prevent an overflow of the enclosing vessel, a high level float switch (N) is engaged allowing 1) notification to operators via audible and/or visual alarm, and/or 2) activation of an automated valve located at the source of the incoming process liquid closing the pipeline to further liquid and preventing flooding of the enclosing vessel.

The entire assembly incorporating the inlet pipe assembly, overflow port, tangential entry, inlet chamber, bell shaped reducing coupling, and submersible vortex pump can be easily removed as one complete assembly from the enclosing vessel for service.

It will be appreciated that the above descriptions are intended only to serve as examples and that many other embodiments are possible within the spirit and the scope of the present invention.

1) A system for transferring low density solids in a liquid medium (hereinafter referred to as “LDSLM”), the system comprising;
a) A receiving, conditioning and pumping apparatus comprised of;
i) an inverted submersible vortex pump;
ii) a bell shaped reducer housing supplying rotationally preconditioned LDSLM to the vortex of the inverted submersible vortex pump from the inlet chamber;
iii) a cylindrical, conical bottomed inlet chamber supplying rotationally preconditioned LDSLM to the bell shaped reducer;
iv) a tangential entry tube attached tangentially to the perimeter of the inlet chamber to induce rotational characteristics into the LDSLM;
v) a cover assembly to supply visual observation and to prevent backsplash;
vi) wherein low-density solids in a liquid medium are transferred from one location to another remote location without need for complicated machinery;
vii) wherein the use of a submersible vortex pump in an inverted manner is novel and unique;
viii) wherein the feeding of the inverted submersible vortex pump's vortex with rotationally pre-conditioned debris laden fluid presents a new and original methodology for the transference of said liquid (LDSLM) without worry of pump cavitation, clogging or fouling;
ix) wherein the process operates without the requirement of chemical treatment of the LDSLM;
x) wherein the process can continuously operate over a wide range of fluid flow including zero gallons per minute.
b) An inlet, overflow and outlet system feeding the receiving, conditioning and pumping apparatus and discharging the LDSLM comprised of;
i) an inlet pipe with a fixed overflow port (opening at a specific height);
ii) a stainless steel screen box of a predetermined perforation size;
iii) a secondary transfer pump to discharge overflow liquid;
iv) a float switch to operate the secondary discharge pump;
v) a swept ell pipe to evacuate LDSLM;
vi) wherein overflow of the device is thwarted and particulates and debris in the excess liquid is separated from the overflow liquid allowing clean liquid to be smoothly discharged back to the originating process.
c) An enclosing vessel assembly comprised of;
i) a stainless steel container with a flat bottom, square at one end and round at the other matching the contour of the inlet chamber and of sufficient height to encompass and contain all the aforementioned equipment;
ii) a float switch to determine high liquid levels to facilitate an orderly shutdown of the upstream process discharging the LDSLM;
iii) wherein overflow liquids can be contained prior to discharge and overflow liquid and process liquid can be re-circulated and periodically changed to provide cooling for the aforementioned pumps and equipment. Provides for ease of movement and maintenance of said apparatus.

2) The system of claim 1, where the inlet chamber is cylindrical and flat bottomed comprising;
a) a vertical piece of pipe attached to the cover assembly directly above and into the pump inlet causing a quieting effect and providing a barrier preventing large objects from entering the pump inlet.

3) The system of claim 1, where the inlet chamber is cylindrical and flat bottomed comprising;
a) a vertical piece of pipe in inserted into the opening of the flat portion of the inlet chamber of the same diameter of the opening in the inlet chamber to provide a small fence like barrier to large materials entering the pump inlet.

4) The system of claims 1, 2 and 3 where a trap and discharge port is at the bottom of the inlet pipe comprising;
a) a vertical opening in the bottom of the inlet tube allowing large objects in the LDSLM to fall into the overflow screen box;
b) an interchangeable blade assembly inserted from the top of the inlet assembly and protruding into the LDSLM stream;
c) wherein large objects in the LDSLM can be caught and directed out of the process flow into the overflow screen box.
